(19) United States
(12) Patent Application Publication
(10) Pub. No.: US 2023/0343322 A1
(43) Pub. Date: Oct. 26, 2023

(54) PROVISION OF VOICE INFORMATION BY USING PRINTOUT ON WHICH ATTRIBUTE INFORMATION OF DOCUMENT IS RECORDED

(71) Applicant: HEWLETT-PACKARD DEVELOPMENT COMPANY, L.P., Spring, TX (US)

(72) Inventors: Yoonsoo LEE, Seongnam-si, Gyeonggi-do (KR); Jihyun YOON, Seongnam-si, Gyeonggi-do (KR); Chulgee LEE, Seongnam-si, Gyeonggi-do (KR)

(21) Appl. No.: 17/790,593

(22) PCT Filed: Oct. 7, 2020
(86) PCT No.: PCT/US2020/054487

§ 371 Date: Jul. 1, 2022

(30) Foreign Application Priority Data
Mar. 31, 2020 (KR) 10-2020-0039058

(51) Int. Cl. G10L 13/08; H04N 1/00; G06F 3/16

(52) U.S. Cl. CPC G10L 13/08; G06F 3/167; H04N 1/00326

(57) ABSTRACT

An example operation method of an image forming apparatus includes identifying a first printout on which first attribute information of a first document is recorded, the first attribute information to describe or to identify the first document, obtaining the first attribute information from the first printout based on a result of the identifying of the first printout, outputting first voice information corresponding to the first attribute information, and performing a first image forming operation on the first printout.

### BACKGROUND

When an image forming apparatus receives a request to copy a certain document, the image forming apparatus converts information included in the document into an image and outputs the image as a printout.

The image forming apparatus may transmit the information included in the printout by voice by converting this information from a digital signal to an analog voice signal.

### BRIEF DESCRIPTION OF THE DRAWINGS

FIG. 1 is a conceptual diagram for explaining an operation performed by an image forming apparatus to provide voice information by using a printout on which attribute information of a document is recorded, according to an example.

FIG. 2 is a flowchart of an operation method performed by an image forming apparatus to provide voice information by using a printout on which attribute information of a document is recorded and to perform an image forming operation on the printout, according to an example.

FIG. 3 is a flowchart of an operation method performed by an image forming apparatus to generate a printout on which attribute information of a document is recorded, according to an example.

FIG. 4 is a diagram for explaining a process of obtaining, by an image forming apparatus, attribute information of a document and generating a printout on which the attribute information is recorded, according to an example.

FIG. 5 is a diagram for explaining a process of changing, by an image forming apparatus, attribute information of a document and generating a printout on which the changed attribute information is recorded, according to an example.

FIG. 6 is a diagram for explaining a process of generating, by an image forming apparatus, an attribute list according to a priority for attribute information and generating a printout on which the attribute list is recorded, according to an example.

FIG. 7 is a diagram for explaining a process of providing attribute information of a printout in the form of voice information and performing an image forming operation on the printout upon identification of the printout on which the attribute information is recorded, according to an example.

FIG. 8 is a diagram for explaining a process of providing customized attribute information corresponding to information requested by a user, according to an example.

FIG. 9 is a diagram for explaining a process of performing an image forming operation according to a request to change attribute information of a document and recording the changed attribute information on a printout when the request is received, according to an example.

FIG. 10 is a diagram for describing a user interface displayed on an image forming apparatus upon identification of a printout on which attribute information of a document is recorded, according to an example.

FIG. 11 is a block diagram illustrating an image forming apparatus, according to an example.

FIG. 12 is a diagram for describing instructions stored in a non-transitory computer-readable storage medium, according to an example.

### DETAILED DESCRIPTION OF EXAMPLES

An “image forming apparatus” may be any type of apparatus capable of performing an image forming operation, such as a printer, a copier, a scanner, a fax machine, a multi-function printer (MFP), or a display device. An “operation performed by the image forming apparatus” may be an operation related to printing, copying, scanning, faxing, storing, sending, or the like.

“Attribute information” may be information used to describe or identify a certain document. The attribute information may be expressed as structured data. The structured data of the attribute information may be referred to as “metadata”.

Examples will be described with reference to the accompanying drawings below so that they may be easily implemented by those of ordinary skill in the art. However, the disclosure may be embodied in many different forms and is not limited to the examples set forth herein.

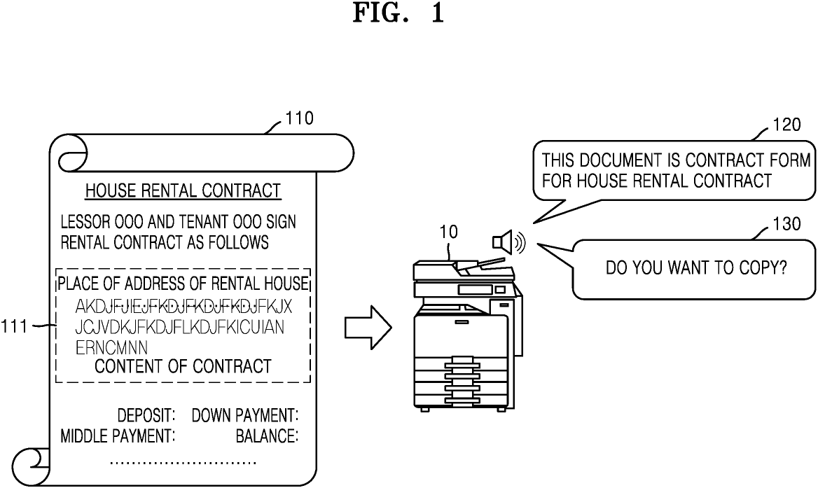

FIG. 1 is a conceptual diagram for explaining an operation performed by an image forming apparatus to provide voice information by using a printout on which attribute information of a document is recorded, according to an example.

Referring to FIG. 1, a printout 110 on which a “house rental contract” is printed may include attribute information of the “house rental contract”. In this case, the attribute information of the “house rental contract” may be recorded on the printout 110 as an electronic code 111 having a certain format. For example, the attribute information of the “house rental contract” may be information about the type of document. The electronic code 111 may be displayed transparently or semi-transparently.

For example, a user may place the printout 110 in a document feeder tray or a scanner of an image forming apparatus 10 to copy the printout 110. The image forming apparatus 10 may identify the printout 110 through the scanner and extract the electronic code 111 based on a result of identifying the printout 110. The image forming apparatus 10 may obtain the attribute information of the “house rental contract” based on the electronic code 111. The image forming apparatus 10 may output voice information corresponding to the attribute information of the “house rental contract” by voice 120 through a speaker.

In addition, after the voice information is output, the image forming apparatus 10 may output voice 130 inquiring whether to perform a certain image forming operation. For example, the image forming apparatus 10 may perform an operation of copying the printout 110 when a request to copy the printout 110 is received.

In order to perform the operation of the image forming apparatus 10 described above with reference to FIG. 1, the image forming apparatus 10 may perform an operation of identifying a certain document and an operation of outputting voice, in addition to the operation of performing the image forming operation. The image forming apparatus 10 may additionally perform an operation of editing the document, an operation of identifying voice, and the like.

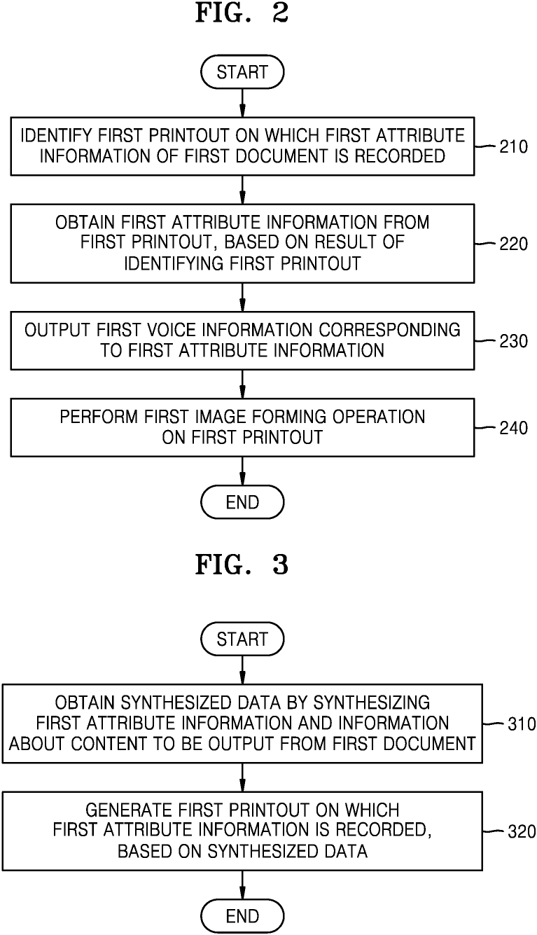

FIG. 2 is a flowchart of an operation method performed by an image forming apparatus to provide voice information by using a printout on which attribute information of a document is recorded and to perform an image forming operation on the printout, according to an example.

Referring to FIG. 2, the image forming apparatus 10 may identify a first printout on which first attribute information of a first document is recorded in operation 210. For example, the first attribute information of the first document may be information used to describe or identify the first document. For example, the image forming apparatus 10 may identify the first printout by reading the first printout through the scanner of the image forming apparatus 10. In this case, the image forming apparatus 10 may check the first attribute information recorded on the first printout and information about content to be output from the first printout.

For example, the first attribute information may include main attribute information such as format information of the first document or summary information about the content to be delivered through the first document. In addition, the first attribute information may include sub-attribute information such as history information of the first document or additional operation information requested with respect to the first document.

For example, the format information of the first document may include a title for identifying the first document, the number of pages of the first document, a direction of the first document, the type of the first document, the color of the first document, and the like. The information about the direction of the first document may be information on whether the direction of the first document is a horizontal direction (e.g., portrait orientation) or a vertical direction (e.g., landscape orientation). The information about the type of the first document may be information about a text document or an image document. The information about the color of the first document may be information as to whether the first document is a black-and-white document or a color document.

For example, the summary information of the first document may include information such as representative words, keywords, phrases, sentences, etc. summarizing the content of the first document. The representative words, the keywords, and the phrases may be determined based on the number of occurrences in the first document. The sentence summarizing the content may be set in advance according to a user input.

For example, the history information of the first document may include an author of the first document, an editor of the first document, a history of modifications to the first document, a history of a writer who modified the first document, and the like.

For example, the additional operation information of the first document may include information about whether certain information should be additionally recorded on the first document to reflect features of the first document. For example, when the first document is a contract, the additional operation information may include information about the subject of the contract, the content of the contract, and the like.

For example, the first attribute information may be recorded as structured data on the first printout. Here, the structured data of the first attribute information may be first metadata. The first attribute information may be expressed in machine language readable by the processor of the image forming apparatus 10. For example, the first metadata may be expressed as an electronic code having a certain format. For example, the electronic code may be a certain character string, a barcode, and the like.

For example, the first attribute information may be expressed as voice data and recorded as the voice data on the first printout. When the image forming apparatus 10 does not support a Text-to-Speech (TTS) function, the image forming apparatus 10 may output the voice data extracted from the first printout to provide the first attribute information to a user.

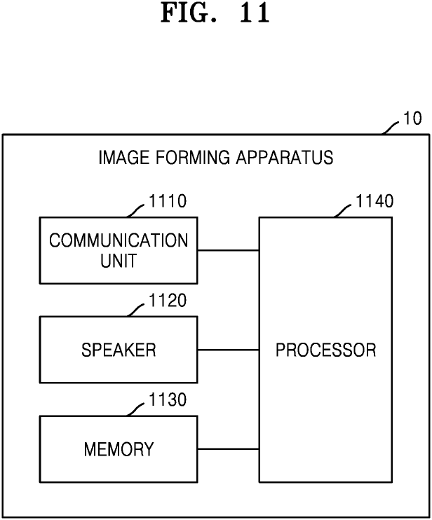

When a printout on which attribute information of a certain document is recorded is identified, the image forming apparatus 10 may enlarge a user interface displayed thereon and display the enlarged user interface based on a screen configuration criterion. For example, the screen configuration criterion may be a criterion for extracting a user interface frequently used by a plurality of users, enlarging the user interface to a certain size, and displaying the enlarged user interface. An example process of enlarging and displaying a user interface will be described with reference to FIG. 10 below.

In operation 220, the image forming apparatus 10 may obtain the first attribute information from the first printout based on a result of identifying the first printout. For example, when the first attribute information is recorded as a first electronic code having a certain format on the first printout, the image forming apparatus 10 may extract the first electronic code based on the result of identifying the first printout.

In addition, the image forming apparatus 10 may receive information requested by a user with respect to the first document. The image forming apparatus 10 may obtain customized attribute information corresponding to the requested information among the first attribute information based on the result of identifying the first printout. For example, the requested information may be the summary information of the first document. The image forming apparatus 10 may obtain the customized attribute information by extracting the summary information of the first document from the first attribute information of the first document.

In operation 230, the image forming apparatus 10 may output first voice information corresponding to the first attribute information. For example, when the first attribute information includes text, the image forming apparatus 10 may obtain the first voice information corresponding to the first attribute information by converting the text into voice through the TTS function. The image forming apparatus 10 may output the first voice information by voice through a speaker of the image forming apparatus 10.

For example, when the first attribute information is encrypted, the image forming apparatus 10 may decrypt the first attribute information and obtain the first voice information corresponding to the first attribute information. For example, when the first attribute information is recorded as voice data, the image forming apparatus 10 may output a voice corresponding to the voice data.

For example, when the first attribute information includes a first attribute list, the image forming apparatus 10 may output the first voice information corresponding to the first attribute information based on the first attribute list in which lower-level attribute information constituting the first attribute information is arranged according to a priority. For example, the priority may correspond to a user input. For example, the priority may be set in the order of summary information of a document, format information of the document, history information of the document, and the like.

When customized attribute information corresponding to information requested by a user is obtained, the image forming apparatus 10 may output voice information corresponding to the customized attribute information. The image forming apparatus 10 may provide the customized attribute information so as to guide the user to identify and work with the first document.

For example, the image forming apparatus 10 may output the first voice information corresponding to the first attribute information in a state in which an operating mode of the image forming apparatus 10 is activated to a visually-impaired assistance mode.

For example, when a request to stop outputting of the first voice information is received during the outputting of the first voice information, the image forming apparatus 10 may stop the outputting of the first voice information. In this case, the image forming apparatus 10 may receive the request to stop the outputting of the first voice information through a user interface unit or a voice recognition unit included in the image forming apparatus 10. The user interface unit may be a user interface device attached to the image forming apparatus 10. The voice recognition unit may be a recorder.

In operation 240, the image forming apparatus 10 may perform a first image forming operation on the first printout. For example, the first image forming operation may include printing, copying, scanning, a scan-to-send operation, a scan-to-optical character recognition (OCR) operation, a scan-to-cloud operation, faxing, and the like. In this case, the image forming apparatus 10 may record second attribute information of a second printout or a file, which is generated through the first image forming operation on the first printout, on the second printout or the file. For example, the second attribute information may be attribute information in which a change in the first attribute information is reflected. When there is no change in the first attribute information due to the first image forming operation, the image forming apparatus 10 may record the first attribute information on the second printout or the file generated through the first image forming operation.

The image forming apparatus 10 may receive a request to change the first attribute information in response to the first voice information. The image forming apparatus 10 may generate a second printout on which second attribute information obtained by changing the first attribute information is recorded, the second printout being a result of reflecting the second attribute information in the first printout.

For example, the request to change the first attribute information may include a request to change the format of the first document, a request to change the content of the first document, and the like.

For example, when the request to change the first attribute information includes a request to change a font size of the first document, the image forming apparatus 10 may obtain second attribute information by changing the font size and generate a second printout reflecting the change in the font size. In this case, the second attribute information may be recorded on the second printout.

For example, the request to change the format of the first document may include a request to change a font, a document direction, a document color, and the like of the first document.

For example, when the request to change the first attribute information is a request to change the content of the first document, the image forming apparatus 10 may obtain second attribute information by changing the content of the first document and generate the second printout reflecting the change in the content of the first document. In this case, the second attribute information may be recorded on the second printout.

FIG. 3 is a flowchart of an operation method performed by an image forming apparatus to generate a printout on which attribute information of a document is recorded, according to an example.

Referring to FIG. 3, the image forming apparatus 10 may obtain synthesized data by synthesizing first attribute information and information about content to be output from a first document in operation 310.

For example, the image forming apparatus 10 may generate a first electronic code having a certain format based on first metadata obtained by structuralizing the first attribute information. For example, the first metadata may be represented as a tree form structured from higher-level data to lower-level data. The image forming apparatus 10 is capable of detecting certain attribute information by expressing the first attribute information as the first metadata. The first metadata may be expressed in machine language readable by a processor in the image forming apparatus 10. The first electronic code may be represented by a certain character string, a barcode, and the like. The image forming apparatus 10 may obtain the synthesized data by synthesizing the first electronic code and the information about the content to be output from the first document.

For example, the image forming apparatus 10 may express the first attribute information as characters recognizable by a user. The image forming apparatus 10 may obtain the synthesized data by synthesizing the first attribute information represented as the characters recognizable by a user and the information about the content to be output from the first document.

For example, when an image forming operation for the first document is requested, the image forming apparatus 10 may read the first document and obtain the first attribute information corresponding to the information about the content of the first document. In an example, the image forming apparatus 10 may obtain the first attribute information separately recorded on the first document based on a result of identifying the first document. In an example, the image forming apparatus 10 may obtain the first attribute information of the first document from an external device or an input from a user.

In operation 320, the image forming apparatus 10 may generate a first printout on which the first attribute information is recorded based on the synthesized data. For example, the image forming apparatus 10 may record the first attribute information on the first printout as first electronic code having a certain format. In an example, the image forming apparatus 10 may record the first attribute information on the first printout as characters recognizable by a user.

For example, the first attribute information may be displayed on the first printout transparently or semi-transparently. In an example, the first attribute information may be displayed in a certain size in a certain area of the first printout. In an example, the first attribute information may be displayed in a blank space of the first printout. The first attribute information recorded on the first printout may not be easy to identify with a user’s naked eye.

For example, the image forming apparatus 10 may generate a first attribute list in which lower-level attribute information constituting the first attribute information is arranged based on a priority for attribute information. The image forming apparatus 10 may generate a first printout on which the first attribute list is recorded.

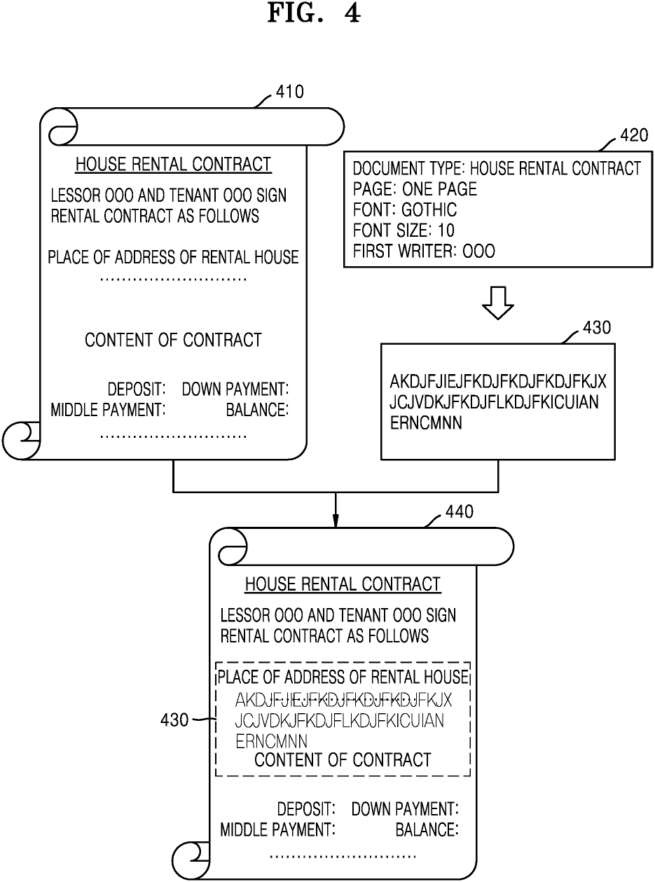

FIG. 4 is a diagram for explaining a process of obtaining, by an image forming apparatus, attribute information of a document and generating a printout on which the attribute information is recorded, according to an example.

The image forming apparatus 10 may generate a printout on which attribute information of a document is recorded while outputting information of content of the document. The attribute information of the document may include information used to describe or identify the document. When the attribute information of the document is provided by voice during an image forming operation performed on the document by a user through the image forming apparatus 10, the user is able to identify the document.

Referring to FIG. 4, the image forming apparatus 10 may receive a request to copy a printout 410 on which a “house rental contract” is printed. As an example, a user may place the printout 410 in the document feeder tray or the scanner of the image forming apparatus 10 to copy the printout 410 on which the “house rental contract” is printed. The image forming apparatus 10 may receive an input to select a “copy” button or a voice signal corresponding to “copy”. The image forming apparatus 10 may obtain first attribute information 420 of the printout 410 before copying the printout 410. That is, the image forming apparatus 10 may obtain the first attribute information 420 of the “house rental contract”. The first attribute information 420 of the “house rental contract” may be obtained based on a result of reading the printout 410, obtained from an external device, obtained from information input by a user, and the like.

For example, the image forming apparatus 10 may read the printout 410 to obtain main attribute information including format information about a format of the “house rental contract” or summary information about content to be delivered through the “house rental contract”.

In addition, the image forming apparatus 10 may read the printout 410 to obtain sub-attribute information including history information of the “house rental contract” or additional operation information requested with respect to the “house rental contract”.

For example, as illustrated in FIG. 4, the image forming apparatus 10 may obtain the first attribute information 420 including information about a document type, pages, a font, a font size, and an author (i.e., first writer). The image forming apparatus 10 may generate a first electronic code 430 based on metadata obtained by structuralizing the first attribute information 420. For example, the first electronic code 430 may be data obtained by encrypting the first attribute information 420 and may include a certain character string. The first electronic code 430 may be a one-dimensional (1D) linear barcode, a two-dimensional (2) barcode, and the like. For example, the 2D barcode may include quick response (QR) code.

The image forming apparatus 10 may obtain synthesized data by synthesizing information about content to be output from the printout 410 and the first electronic code 430. The image forming apparatus 10 may generate a first printout 440 on which the first electronic code 430 is recorded based on the synthesized data. In addition, the image forming apparatus 10 may generate a printout on which attribute information expressed as characters recognizable by a user is recorded.

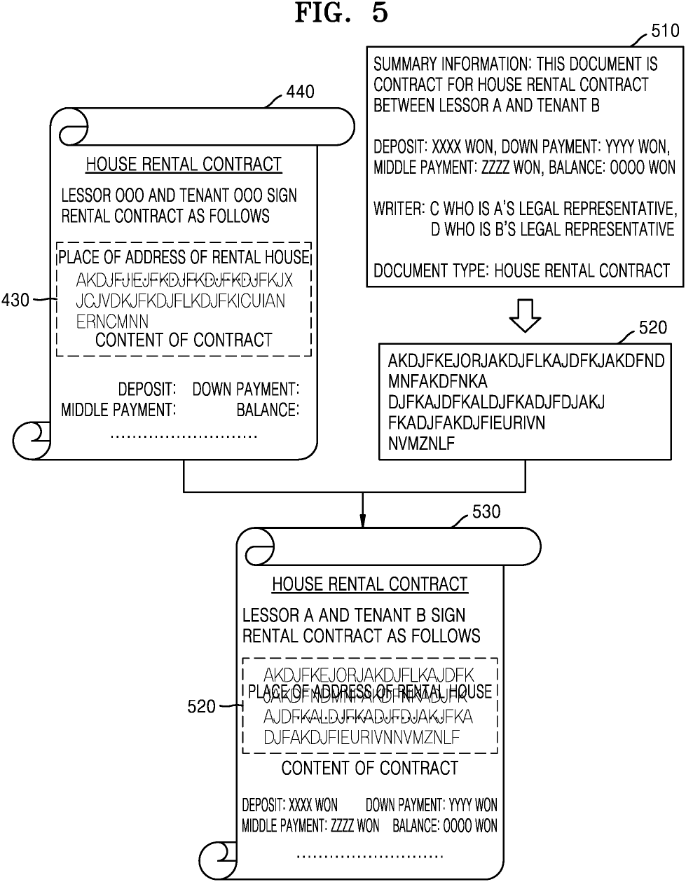

FIG. 5 is a diagram for explaining a process of changing, by an image forming apparatus, attribute information of a document and generating a printout on which the changed attribute information is recorded, according to an example.

A user may change a format or content of a document according to a type, a feature, a use, etc. of the document. As the format or content of the document is changed, the image forming apparatus 10 may change existing first attribute information to second attribute information. The image forming apparatus 10 may generate a printout including the changed format or content of the document. In this case, the second attribute information may be recorded on the printout.

Referring to FIG. 5, the user may attempt to record information of the house rental contract on the first printout 440 on which the “house rental contract” is printed. The image forming apparatus 10 may generate a second printout 530 on which the information of the house rental contract is recorded in addition to the “house rental contract”.

For example, the image forming apparatus 10 may identify the first printout 440 on which the first electronic code 430 representing the first attribute information 420 of the “house rental contract” is recorded. The image forming apparatus 10 may obtain second attribute information 510 of the house rental contract. Here, the image forming apparatus 10 may receive text information of the second attribute information 510 through the user interface unit in the image forming apparatus 10 or receive voice information of the second attribute information 510 through the voice recognition unit in the image forming apparatus 10.

For example, the second attribute information 510 may include summary information of the house rental contract, information about an amount of money, information about an author or a party to the contract, information about a document type, and the like. The image forming apparatus 10 may generate a second electronic code 520 corresponding to the second attribute information 510.

The image forming apparatus 10 may remove the first electronic code 430 from the first printout 440, and obtain temporary data including the “house rental contract” with the information of the house rental contract based on the second attribute information 510. The image forming apparatus 10 may generate the second printout 530 including the second attribute information 510 by synthesizing the temporary data and the second electronic code 520.

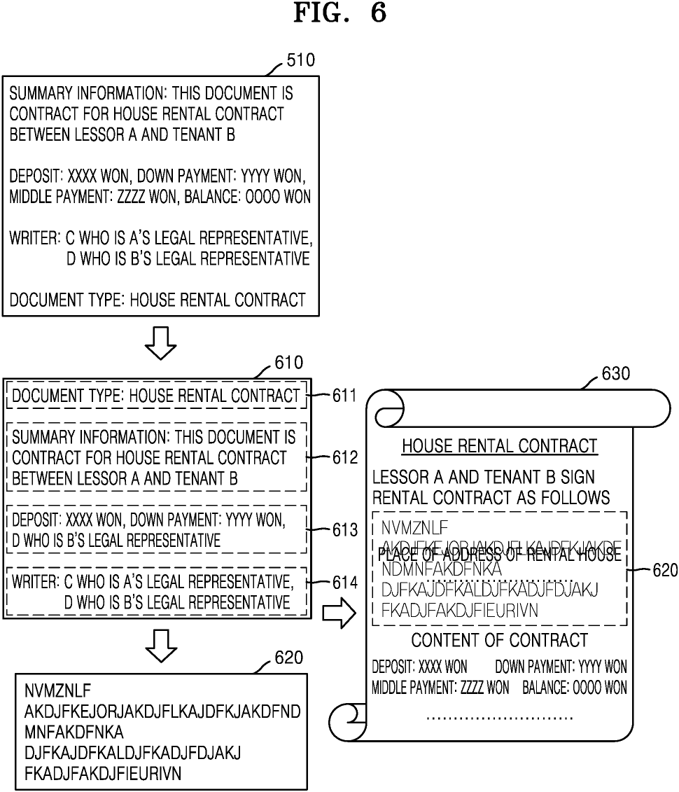

FIG. 6 is a diagram for explaining a process of generating, by an image forming apparatus, an attribute list according to a priority for attribute information and generating a printout on which the attribute list is recorded, according to an example.

When attribute information of a document is provided by voice in the image forming apparatus 10, a user is able to identify the document according to the attribute information provided to the user and reduce a working time of the document. Accordingly, the image forming apparatus 10 may generate an attribute list in which attribute information is listed based on a priority for the attribute information.

In an example, the priority may be set based on a user input or attribute information requested by the user. For example, the priority may be set in the order of summary information to be delivered through the document, format information about a format of the document, history information of the document, additional operation information with respect to the document, and the like. The priority may be set in the order of main attribute information and sub-attribute information. The image forming apparatus 10 may generate an electronic code corresponding to the attribute list and generate a printout on which the electronic code corresponding to the attribute list is recorded. The image forming apparatus 10 may output the attribute information by voice in the order in which the attribute information is arranged in the attribute list.

Referring to FIG. 6, the image forming apparatus 10 may obtain the second attribute information 510 of a house rental contract. The image forming apparatus 10 may obtain third attribute information 610 by rearranging lower-level attribute information constituting the second attribute information 510 based on the priority for the attribute information. That is, the third attribute information 610 may represent an attribute list in which lower-level attribute information constituting the attribute information is arranged according to the priority.

For example, in the third attribute information 610, information 611 about a document format, summary information 612 of the house rental contract, information 613 about an amount of money, and information 614 about a writer (e.g., a signatory or party to the contract) may be arranged. The image forming apparatus 10 may generate a third electronic code 620 corresponding to the third attribute information 610.

The image forming apparatus 10 may remove the first electronic code 430 from the first printout 440, and obtain temporary data of the “house rental contract” including information of the house rental contract based on the third attribute information 610 in which the attribute information is arranged according to the priority. The image forming apparatus 10 may generate a third printout 630 including the third attribute information 610 by synthesizing the temporary data and the third electronic code 620.

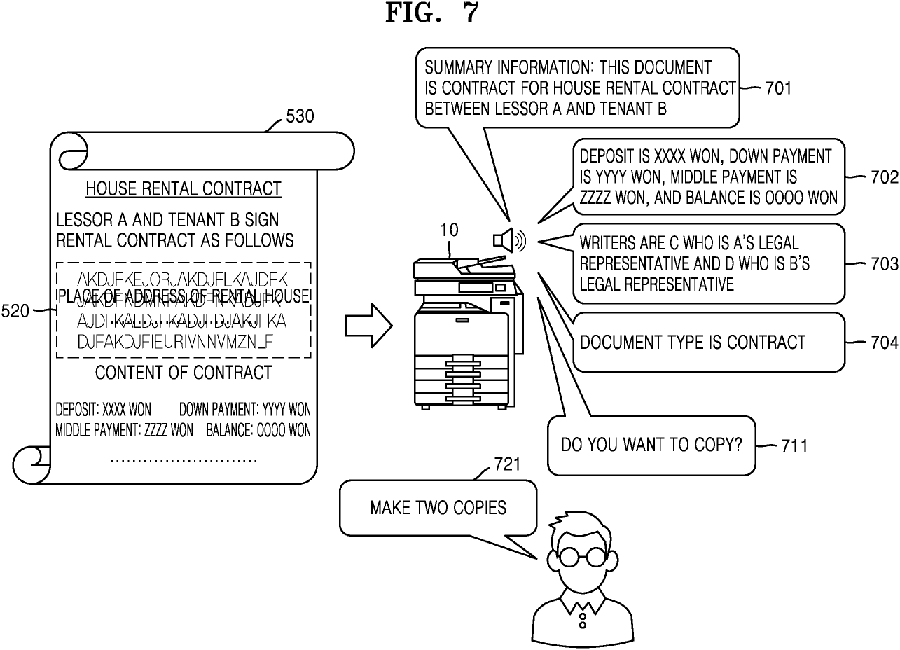

FIG. 7 is a diagram for explaining a process of providing attribute information of a printout in the form of voice information and performing an image forming operation on the printout upon identification of the printout on which the attribute information is recorded, according to an example.

When a printout on which attribute information of a document is recorded is identified before a certain image forming operation is performed by the image forming apparatus 10, the image forming apparatus 10 may obtain the attribute information based on a result of identifying the printout, and output voice information corresponding to the information by voice. Because the attribute information of the printout is provided before the image forming operation is performed, a user is able to identify the printout. In addition, because the attribute information is output by voice, even a user with visual disability is able to identify the printout. The image forming apparatus 10 may perform the image forming operation according to a request from the user.

Referring to FIG. 7, the image forming apparatus 10 may identify a second printout 530 on which a second electronic code 520 representing second attribute information 510 of a “house rental contract” is recorded. Here, the second attribute information 510 may include summary information of the house rental contract, information about an amount of money, information about a writer, information about a format of the document, and the like.

The image forming apparatus 10 may output voice information corresponding to the second attribute information 510 by voice. As an example, the image forming apparatus 10 may output voice information representing the summary information of the house rental contract by voice 701. The image forming apparatus 10 may output voice information representing the information about the amount of money by voice 702. The image forming apparatus 10 may output voice information representing the information about the writer by voice 703. In addition, the image forming apparatus 10 may output voice information representing the information about the format of the document by voice 704.

For example, the image forming apparatus 10 may output voice information corresponding to lower-level attribute information constituting the second attribute information 510 based on a priority for the attribute information.

When the outputting of the voice information corresponding to the second attribute information 510 is completed, the image forming apparatus 10 may output a voice inquiring whether to perform a certain image forming operation. For example, the image forming apparatus 10 may output a voice 711 inquiring whether to copy the second printout 530 of the “house rental contract”. A user may listen to the voice 711 and make a response 721 to the voice 711. The image forming apparatus 10 may perform an operation of copying the second printout 530 according to the response 721.

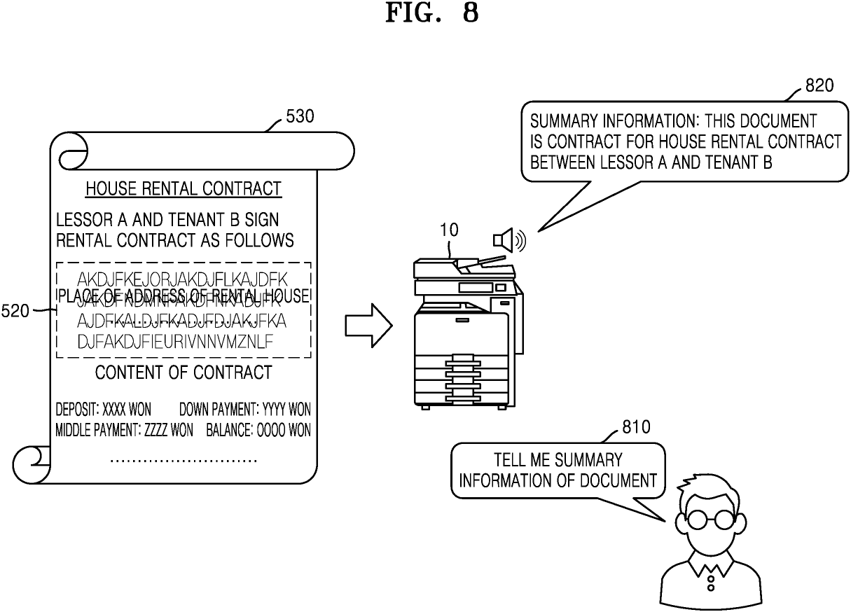

FIG. 8 is a diagram for explaining a process of providing customized attribute information corresponding to information requested by a user, according to an example.

A user may request the user’s information of interest with respect to a document, and the image forming apparatus 10 may extract customized attribute information corresponding to the information of interest from attribute information of the document. The image forming apparatus 10 may output voice information corresponding to the customized attribute information.

Referring to FIG. 8, the image forming apparatus 10 may identify a second printout 530 on which a second electronic code 520 representing second attribute information 510 of a “house rental contract” is recorded. Here, the second attribute information 510 may include summary information of the house rental contract, information about an amount of money, information about a writer, information about a format of the document, and the like.

The image forming apparatus 10 may receive the user’s voice 810 requesting the summary information of the house rental contract. The image forming apparatus 10 may extract the second electronic code 520 corresponding to the second attribute information 510 based on a result of identifying the second printout 530, and obtain the second attribute information 510. The image forming apparatus 10 may extract the summary information of the house rental contract from the second attribute information 510. The image forming apparatus 10 may output voice information representing the summary information of the house rental contract by a voice 820. By providing the attribute information corresponding to the user’s information of interest by voice, the attribute information of the document may be provided efficiently.

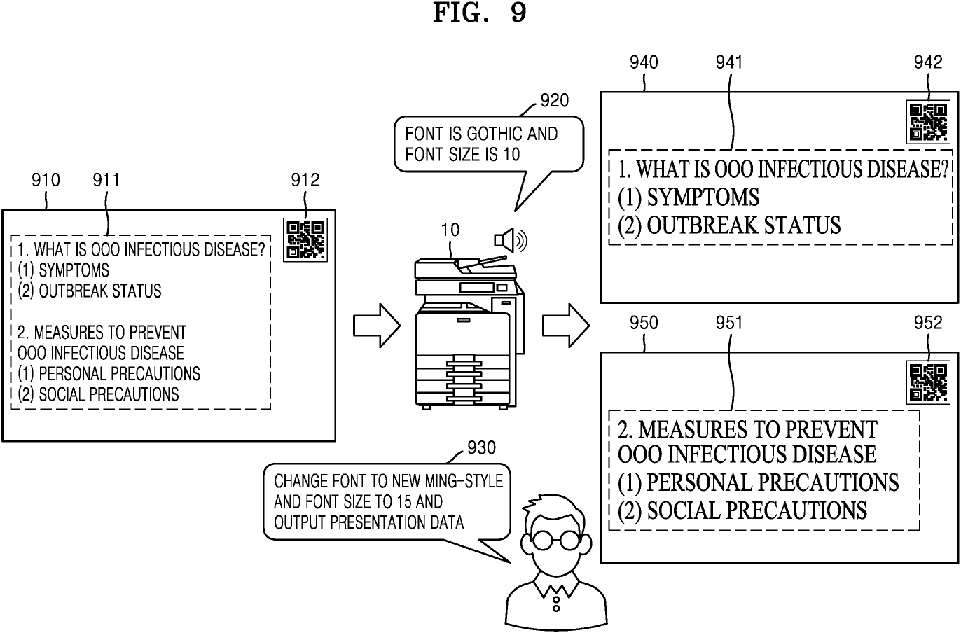

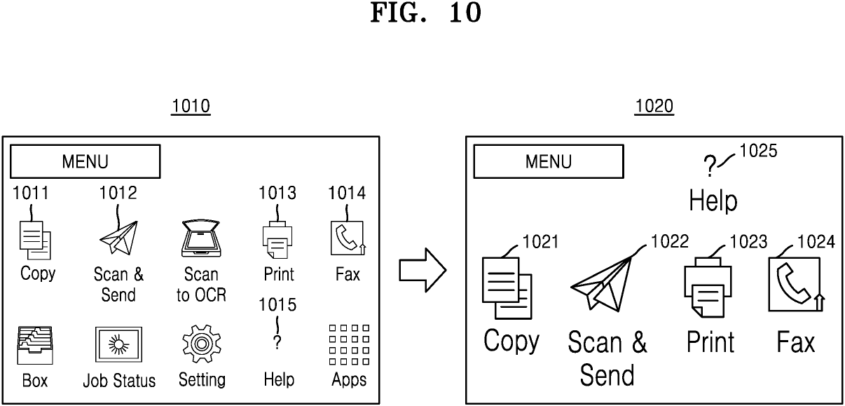

FIG. 9 is a diagram for explaining a process of performing an image forming operation according to a request to change attribute information of a document and recording the changed attribute information on a printout when the request is received, according to an example.

When a first printout on which first attribute information of a document is recorded is identified by the image forming apparatus 10, the image forming apparatus 10 may obtain the first attribute information based on a result of identifying the first printout, and output first voice information corresponding to the first attribute information by voice. The image forming apparatus 10 may receive a request to change the first attribute information in response to the first voice information. The image forming apparatus 10 may generate a second printout on which second attribute information obtained by changing the first attribute information is recorded to reflect the second attribute information in the first printout.

Referring to FIG. 9, a user may output a document about OOO infectious disease for a presentation related to the OOO infectious disease. For example, in order to copy a printout 910 on which presentation data 911 of the OOO infectious disease is printed, a user may place the printout 910 in the document feeder tray or the scanner of the image forming apparatus 10. First attribute information of the presentation data 911 of the OOO infectious disease may be recorded on the printout 910. For example, the first attribute information may be recorded as a first QR code 912. The first attribute information may include information about a font and a font size of the presentation data 911 of the OOO infectious disease.

The image forming apparatus 10 may receive an input to select a “copy” button or a voice signal corresponding to “copy”. In this case, the image forming apparatus 10 may identify the printout 910 and obtain the first QR code 912 from the printout 910. The image forming apparatus 10 may output voice information corresponding to the first QR code 912 by a voice 920. The voice information may be information about the font and the font size of the presentation data 911.

The user may listen to the voice 920 and want to change the font and the font size of the presentation data 911. The image forming apparatus 10 may receive a voice 930 corresponding to a request to change the font and the font size of the presentation data 911. For example, the request to change the font and the font size of the presentation data 911 may be a request to change the font from Gothic to New Ming-style and the font size from 10 to 15 and output the resultant presentation data 911.

Based on the request to change the font and the font size of the presentation data 911, the image forming apparatus 10 may change the font of the presentation data 911 to New Ming-style and the font size to 15 and output printouts 940 and 950. In this case, as the font size is increased, the number of pages of the presentation data may increase. The printout 940 may include presentation data 941 titled “What is OOO infectious disease?”, and the printout 950 may include presentation data 951 titled “Measures to prevent OOO infectious disease”. The printout 940 may further include a second QR code 942 corresponding to attribute information of the presentation data 941, and the printout 950 may further include a third QR code 952 corresponding to attribute information of the presentation data 951.

FIG. 10 is a diagram for describing a user interface displayed on an image forming apparatus upon identification of a printout on which attribute information of a document is recorded, according to an example.

When a printout on which attribute information of a certain document is recorded is identified by the image forming apparatus 10, the image forming apparatus 10 may enlarge and display a user interface displayed thereon based on a screen configuration criterion. For example, the screen configuration criterion may be a criterion for extracting a user interface frequently used by a plurality of users, enlarging the user interface to a certain size, displaying the enlarged user interface, and the like.

An image 1010 of FIG. 10 represents a menu screen displayed on the user interface unit in a normal operational state of the image forming apparatus 10. As shown in the image 1010, a copy icon 1011, a scan & send icon 1012, a scan-to-OCR icon, a print icon 1013, a fax icon 1014, a box icon, a job status icon, a setting icon, a help icon 1015, and the like may be displayed on the menu screen.

For example, icons selected more than a certain number of times for a certain period of time may be the copy icon 1011, the scan & send icon 1012, the print icon 1013, the fax icon 1014, and the help icon 1015.

When a printout on which attribute information of a certain document is recorded is identified by the image forming apparatus 10, the image forming apparatus 10 may enlarge the copy icon 1011, the scan & send icon 1012, the print icon 1013, the fax icon 1014, and the help icon 1015 among a plurality of icons and display a result of the enlargement on the menu screen.

As shown in an image 1020 of FIG. 10, the image forming apparatus 10 may display an enlarged copy icon 1021, an enlarged scan & send icon 1022, an enlarged print icon 1023, an enlarged fax icon 1024, and an enlarged help icon 1025 on the menu screen.

In a state in which an operating mode of the image forming apparatus 10 is activated to the visually-impaired assistance mode, the image forming apparatus 10 may enlarge a user interface displayed thereon and display the enlarged user interface based on a screen configuration criterion.

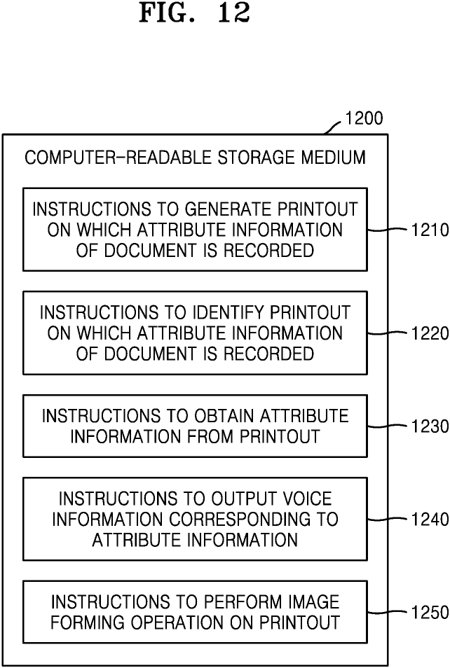

FIG. 11 is a block diagram illustrating an image forming apparatus, according to an example.

Referring to FIG. 11 the image forming apparatus 10 may include a communication unit 1110, a speaker 1120, a memory 1130, and a processor 1140. However, the image forming apparatus 10 may include more components or fewer components than the illustrated components. These components will be described below.

The communication unit 1110 may communicate with an external device. In an example, the communication unit 1110 may be connected to a network by wire or wirelessly to communicate with the external device. Here, the external device may be an external server that manages the image forming apparatus 10 or an electronic device that requests the image forming apparatus 10 to perform a certain operation. The communication unit 1110 may include a communication module (e.g., transceiver) supporting one of various wired/wireless communication methods. For example, the communication module may be a short-range communication module or a wired communication module.

The speaker 1120 may output a voice corresponding to certain voice information. The speaker 1120 may output, by a voice, guide information to be delivered to a user from the image forming apparatus 10.

The memory 1130 may store software, programs, and the like. The memory 1130 may store a program related to an operation of the image forming apparatus 10 that outputs voice information corresponding to attribute information and performs an image forming operation according to a request from a user when a printout on which the attribute information is recorded is identified and an operation of the image forming apparatus 10 that generates a printout on which attribute information is recorded.

The processor 1140 may execute a program stored in the memory 1130, read data or a file stored in the memory 1130, store a new file in the memory 1130, and the like. The processor 1140 may execute instructions stored in the memory 1130.

The processor 1140 may identify a first printout on which first attribute information of a first document is recorded. For example, the first attribute information of the first document may be information used to describe or identify the first document. For example, the image forming apparatus 10 may identify the first printout by reading the first printout through the scanner in the image forming apparatus 10. In this case, the image forming apparatus 10 may check the first attribute information recorded on the first printout and information about content to be output from the first printout.

For example, the first attribute information may include main attribute information that includes format information about a format of the first document or summary information about content to be delivered through the first document. In addition, the first attribute information may include sub-attribute information that includes history information of the first document or additional operation information requested with respect to the first document.

For example, the first attribute information may be recorded as structured data on the first printout. Here, the structured data of the first attribute information may be first metadata. The first attribute information may be expressed in machine language readable by the processor 1140. For example, the first metadata may be expressed as an electronic code having a certain format. For example, the electronic code may be a certain character string, a barcode, and the like.

For example, the first attribute information may be expressed as voice data and recorded as the voice data on the first printout. When the TTS function is not supported by the image forming apparatus 10, the image forming apparatus 10 may provide first attribute information to a user by outputting voice data extracted from the first printout.

When a printout on which attribute information of a certain document is recorded is identified, the processor 1140 may enlarge a user interface displayed on a user interface unit and display the enlarged user interface based on a screen configuration criterion. For example, the screen configuration criterion may be a criterion for extracting a user interface frequently used by a plurality of users, enlarging the user interface to a certain size, and displaying the enlarged user interface.

The processor 1140 may obtain the first attribute information from the first printout based on a result of identifying the first printout. For example, when the first attribute information is recorded as a first electronic code having a certain format on the first printout, the image forming apparatus 10 may extract the first electronic code based on a result of identifying the first printout.

In addition, the image forming apparatus 10 may receive information requested by a user with respect to the first document. The processor 1140 may obtain customized attribute information of the first attribute information corresponding to the requested information based on the result of identifying the first printout. For example, the requested information may be the summary information of the first document. The processor 1140 may obtain the customized attribute information by extracting the summary information of the first document from the first attribute information of the first document.

The processor 1140 may control the speaker 1120 to output first voice information corresponding to the first attribute information. For example, when the first attribute information includes text, the processor 1140 may obtain the first voice information corresponding to the first attribute information by converting the text into voice through the TTS function. The processor 1140 may output the first voice information by a voice through the speaker 1120.

For example, when the first attribute information is encrypted, the processor 1140 may decrypt the first attribute information and obtain the first voice information corresponding to the first attribute information. For example, when the first attribute information is recorded as voice data, the processor 1140 may output a voice corresponding to the voice data.

For example, when the first attribute information includes a first attribute list, the processor 1140 may control the first voice information corresponding to the first attribute information to be output via the speaker 1120 based on the first attribute list in which lower-level attribute information constituting the first attribute information is arranged according to a priority. For example, the priority may be determined according to a user input. For example, the priority may be set in the order of summary information of a document, format information of the document, history information of the document, and the like.

When customized attribute information corresponding to information requested by a user is obtained, the processor 1140 may output voice information corresponding to the customized attribute information via the speaker 1120. The image forming apparatus 10 may provide the customized attribute information to a user so as to guide the user to identify and work with the first document.

For example, the processor 1140 may control the first voice information corresponding to the first attribute information to be output via the speaker 1120 in a state in which an operation mode of the image forming apparatus 10 is activated to the visually-impaired assistance mode.

For example, when a request to stop outputting the first voice information is received during the outputting of the first voice information, the processor 1140 may stop outputting the first voice information. In this case, the processor 1140 may receive the request to stop outputting the first voice information through a user interface unit or a voice recognition unit included in the image forming apparatus 10. The user interface unit may be a user interface device attached to the image forming apparatus 10. The voice recognition unit may be a recorder.

The processor 1140 may perform a first image forming operation on a first printout. For example, the first image forming operation may be an operation from among printing, copying, scanning, a scan-to-send operation, a scan-to-OCR operation, a scan-to-cloud operation, or faxing. In this case, the processor 1140 may record second attribute information of a second printout or a file, which is generated through the first image forming operation on the first printout, on the second printout or the file. For example, the second attribute information may be attribute information reflecting a change in the first attribute information. When there is no change in the first attribute information due to the first image forming operation, the processor 1140 may record the first attribute information on the second printout or the file generated through the first image forming operation.

The processor 1140 may obtain a request to change the first attribute information in response to the first voice information. The processor 1140 may generate a second printout on which second attribute information obtained by changing the first attribute information is recorded, the second printout being a result of reflecting the second attribute information in the first printout.

For example, the request to change the first attribute information may include a request to change the format of the first document, a request to change the content of the first document, and the like.

For example, when the request to change the first attribute information is a request to change a font size of the first document, the processor 1140 may obtain second attribute information by changing the font size and generate a second printout reflecting the change in the font size. In this case, the second attribute information may be recorded on the second printout.

For example, the request to change the format of the first document may include a request to change a font, a document direction, a document color of the first document, and the like.

For example, when the request to change the first attribute information is a request to change content of the first document, the processor 1140 may obtain second attribute information by changing the content of the first document and generate the second printout reflecting the change in the content of the first document. In this case, the second attribute information may be recorded on the second printout.

The processor 1140 may obtain synthesized data by synthesizing the first electronic code and the information about the content to be output from the first document.

For example, the processor 1140 may generate a first electronic code having a certain format based on first metadata obtained by structuralizing the first attribute information. For example, the first metadata may be represented as a tree structured from higher-level data to lower-level data. The processor 1140 may express the first attribute information as the first metadata, thereby enabling attribute information to be detected. The first metadata may be expressed in machine language readable by the processor 1140 of the image forming apparatus 10. The first electronic code may be represented by a certain character string, a barcode, and the like. The processor 1140 may obtain synthesized data by synthesizing the first electronic code and information about the content to be output from the first document.

For example, the processor 1140 may express the first attribute information as characters recognizable by a user. The processor 1140 may obtain synthesized data by synthesizing the first attribute information expressed as the characters recognizable by the user and the information about the content to be output from the first document.

For example, when an image forming operation for the first document is requested, the processor 1140 may read the first document and obtain the first attribute information corresponding to the information about the content of the first document. In an example, the processor 1140 may obtain the first attribute information separately recorded in the first document based on a result of identifying the first document. In an example, the image forming apparatus 10 may obtain the first attribute information of the first document from an external device or an input from a user.

The processor 1140 may generate a first printout on which the first attribute information is recorded based on the synthesized data. For example, the processor 1140 may record the first attribute information on the first printout in a first electronic code having a certain format. In an example, the image forming apparatus 10 may record the first attribute information on the first printout in characters recognizable by a user.

For example, the first attribute information may be displayed on the first printout transparently or semi-transparently. In an example, the first attribute information may be displayed in a certain size in a certain area of the first printout. In an example, the first attribute information may be displayed in a blank space of the first printout. The first attribute information recorded on the first printout may not be easy to identify with a user’s naked eye.

For example, the processor 1140 may generate a first attribute list in which lower-level attribute information constituting the first attribute information is arranged based on the priority for the attribute information. The processor 1140 may generate a first printout on which the first attribute list is recorded.

FIG. 12 is a diagram for describing instructions stored in a non-transitory computer-readable storage medium, according to an example.

Referring to FIG. 12, a non-transitory computer-readable storage medium 1200 may store instructions related to an operation of the image forming apparatus 10 described above with reference to FIGS. 1 to 11. For example, the computer-readable storage medium 1200 may store instructions 1210 to generate a printout on which attribute information of a document is recorded, instructions 1220 to identify the printout on which the attribute information of the document is recorded, instructions 1230 to obtain the attribute information from the printout, instructions 1240 to output voice information corresponding to the attribute information, and instructions 1250 to perform an image forming operation on the printout.

An example operation method of an image forming apparatus described above may be embodied as a non-transitory computer-readable storage medium that stores instructions or data executable by a computer or processor. The operation method of an image forming apparatus may be embodied as a program executable by a computer and implemented in a general-purpose digital computer that operates such a program using a non-transitory computer-readable storage medium. Such a non-transitory computer-readable storage media may be read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard discs, solid-state disks (SSDs), or any types of devices capable of storing instructions or software, related data, data files, and data structures and providing a processor or a computer with instructions or software, related data, data files, and data structures so that the instructions may be implemented by the processor or the computer.

While the disclosure has been described above with reference to various examples and drawings, various modifications may be made therein by those of ordinary skill in the art based on the above description. For example, an appropriate result is achievable even when the above-described techniques are performed in a different order than that described herein and/or when the components of the systems, structures, devices, circuits, and the like described herein are coupled to or combined with each other in a different form than that described herein or replaced or substituted with other components or equivalents.

It should be understood that examples described herein should be considered in a descriptive sense only and not for purposes of limitation. Descriptions of features or aspects within each example should typically be considered as available for other similar features or aspects in other examples. While examples have been described with reference to the figures, it will be understood by those of ordinary skill in the art that various changes in form and details may be made therein without departing from the spirit and scope as defined by the following claims.

What is claimed is:

1. An operation method of an image forming apparatus, the operation method comprising:
identifying a first printout on which first attribute information of a first document is recorded, the first attribute information to describe or to identify the first document;
obtaining the first attribute information from the first printout based on a result of the identifying of the first printout;
outputting first voice information corresponding to the first attribute information; and
performing a first image forming operation on the first printout.

2. The operation method of claim 1, further comprising:
obtaining synthesized data by synthesizing the first attribute information and information about content to be output from the first document; and
generating the first printout on which the first attribute information is recorded based on the synthesized data.

3. The operation method of claim 1, wherein the first attribute information comprises:
main attribute information including format information about a format of the first document or summary information of content to be delivered through the first document; and
sub-attribute information including history information of the first document or additional operation information requested with respect to the first document.

4. The operation method of claim 2, wherein the generating of the first printout comprises:
generating a first attribute list in which lower-level attribute information constituting the first attribute information is arranged based on a priority for attribute information; and
generating the first printout on which the first attribute list is recorded.

5. The operation method of claim 1,
wherein the obtaining of the first attribute information from the first printout comprises:
receiving information requested by a user with respect to the first document; and
obtaining customized attribute information corresponding to the requested information among the first attribute information based on a result of the identifying of the printout, and
wherein the outputting of the first voice information corresponding to the first attribute information comprises outputting voice information corresponding to the customized attribute information.

6. The operation method of claim 1, wherein the outputting of the first voice information corresponding to the first attribute information comprises outputting the first voice information corresponding to the first attribute information based on a first attribute list in which lower-level attribute information constituting the first attribute information is arranged according to a priority.

7. The operation method of claim 2, wherein the obtaining of the synthesized data by synthesizing the first attribute information and the information about the content to be output from the first document comprises:
generating a first electronic code based on first metadata obtained by structuralizing the first attribute information; and
obtaining the synthesized data by synthesizing the first electronic code and the information about the content to be output from the first document.

8. The operation method of claim 2, wherein the obtaining of the synthesized data by synthesizing the first attribute information and the information about the content to be output from the first document comprises, in response to a request to perform the first image forming operation for the first document, reading the first document and obtaining the first attribute information corresponding to the information about the content of the first document.

9. The operation method of claim 1, further comprising:
receiving a request to change the first attribute information in response to the first voice information; and
generating a second printout on which second attribute information obtained by changing the first attribute information is recorded, the second printout being a result of reflecting the second attribute information in the first printout.

10. The operation method of claim 9, wherein the request to change the first attribute information comprises a request to change a format of the first document or a request to change content of the first document.

11. The operation method of claim 1, wherein the outputting of the first voice information corresponding to the first attribute information comprises outputting the first voice information in a state in which an operating mode of the image forming apparatus is activated to a visually-impaired assistance mode.

12. The operation method of claim 1, further comprising, upon identifying a printout on which attribute information of a certain document is recorded, enlarging a user interface displayed on the image forming apparatus and displaying the enlarged user interface based on a screen configuration criterion.

13. A non-transitory computer-readable storage medium storing instructions executable by a processor, the non-transitory computer-readable storage medium comprising:
instructions to identify a first printout on which first attribute information of a first document is recorded, the first attribute information being used to describe or identify the first document;
instructions to obtain the first attribute information from the first printout based on a result of the identifying of the first printout;
instructions to output first voice information corresponding to the first attribute information; and
instructions to perform a first image forming operation on the first printout.

14. An image forming apparatus comprising:
a communication unit;
a speaker;
a processor; and
a memory to store instructions executable by the processor,
wherein the processor executes the instructions to:
identify a first printout on which first attribute information of a first document is recorded, the first attribute information being used to describe or identify the first document;
obtain the first attribute information from the first printout based on a result of the identifying of the first printout;
output first voice information corresponding to the first attribute information via the speaker; and
perform a first image forming operation on the first printout.

15. The image forming apparatus of claim 14, wherein the processor executes the instructions to:
obtain synthesized data by synthesizing the first attribute information and information about content to be output from the first document; and
generate the first printout on which the first attribute information is recorded based on the synthesized data.
